(19) United States
(12) Patent Application Publication
(10) Pub. No.: US 2026/0284940 A1
(43) Pub. Date: Sep. 24, 2026

(54) Compression moulding method and apparatus

(71) Applicant: SACMI COOPERATIVA MECCANICI IMOLA SOCIETA’ COOPERATIVA, Imola (BO) (IT)

(72) Inventors: Fabrizio VILLA, Imola (BO) (IT); Roberto CIPOLLINI, Imola (BO) (IT); Riccardo PIANCASTELLI, Imola (BO) (IT); Piero MARETTI, Imola (BO) (IT)

(21) Appl. No.: 19/478,788

(22) PCT Filed: Apr. 19, 2024
(86) PCT No.: PCT/IB2024/053848

§ 371 Date: Oct. 24, 2025

(30) Foreign Application Priority Data
Apr. 27, 2023 (IT) 1020230000083

(51) Int. Cl. B29C 43/56; B29C 43/04; B29C 43/18; B29C 43/34; B29C 43/36; B29L 31/56

(52) U.S. Cl. CPC B29C 43/56; B29C 43/04; B29C 43/18; B29C 43/34; B29C 43/36; B29C 2043/3416; B29C 2043/3472; B29C 2043/3694; B29C 2043/563; B29L 2031/565

(57) ABSTRACT

A method and an apparatus are disclosed for compression moulding material on an object, in particular to mould a gasket on a capsule for closing containers, in which: a dose of the material is deposited on a base of the object at a distance from a side wall of the object so as to generate an annular space comprised between the dose and the side wall; a contact portion of the side wall is brought into sealing contact with an annular portion of an upper half-unit of a moulding unit for defining a chamber that includes the aforesaid annular space; before compression moulding the material, the chamber is put into communication with a suction feature to generate a vacuum in the annular space, so as to evacuate the air and prevent an inclusion of air in the moulded material.

### BACKGROUND OF THE INVENTION

The invention relates to a method and an apparatus for compression moulding a dose of material, in particular for moulding a dose of sealing material that is suitable for forming gaskets.

Specifically, but not exclusively, the invention can be applied to form an annular gasket on an object, for example on a capsule (made of metal or plastics) for closing a container.

The prior art comprises patent publication US 2012/0171381 A1 that discloses an annular dose of sealing material being applied and moulded to form a gasket on a closing capsule.

Patent publication US 2006/284339 A1 discloses a moulding method according to the preamble of the first claim.

One of the problems of the prior art is to mould a dose of material (in particular, sealing material suitable for forming a gasket) on an object (for example, a capsule for closing containers), in particular on a base of an object and inside a side wall of the object, without air inclusions forming between the moulded material and the object, in particular in the transition zone between the base and the side wall of the object.

### BACKGROUND OF THE INVENTION

One object of the invention is to propose a moulding method and apparatus that is able to solve the aforesaid problem of the prior art.

One object of the invention is to provide a moulding method and apparatus, in particular for compression moulding of a dose of sealing material that is suitable for forming gaskets, which are alternative to those of the prior art.

One advantage is to make an apparatus available that is constructionally simple and cheap to mould a dose of material on an object, in particular to form a gasket in a closing capsule.

One advantage is to mould a dose of material on a base of an object and inside a side wall of the object without leaving air inclusions in the transition zone between the base and the side wall of the object.

One advantage is to mould a dose of sealing material, in particular an annular dose, to form a gasket of a capsule for closing containers, without leaving air inclusions in the gasket, in particular in a transition zone between a base and a side wall of the capsule.

Such objects and advantages, and still others, are achieved by a method and/or an apparatus according to one or more of the claims set out below.

In one embodiment, a method for compression moulding material on an object comprises the steps of: applying a dose of the material to a base of the object at a distance from a side wall of the object so as to generate an annular space comprised between the dose and the side wall; placing in sealing contact a contact portion of the side wall with an annular portion of a moulding unit to define a chamber that includes the aforesaid annular space; and, before compression moulding the material, placing the aforesaid chamber in communication with a suction for generating a vacuum in the annular space and thus preventing an undesired air pocket in the moulded material.

In particular, the method may involve using elastic means for springing a movement (in particular, an axial movement along a compression-moulding direction) between two parts of the moulding unit, in particular between two parts of an upper half-unit of the moulding unit, to actuate the opening of a communication passage of the chamber communicating with the suction.

### BRIEF DESCRIPTION OF THE DRAWINGS

The invention can be better understood and implemented with reference to the appended drawings that illustrate some embodiments thereof by way of non-limiting example, in which:

FIG. 1 shows a top plan view of a plant for producing capsules for closing containers that includes an apparatus for applying a dose to a capsule and an apparatus for moulding the dose and forming a gasket, made according to the present invention;

FIG. 2 is the section II-II of FIG. 1 according to a vertical section plane at the apparatus for applying a dose;

FIG. 3 is a sectioned perspective view of the apparatus for moulding the dose of the plant of FIG. 1;

FIG. 4 shows an enlarged detail of FIG. 3;

FIG. 5 is a top plan view of the apparatus of FIG. 3;

FIGS. 6 to 12 are respectively sections from VI to XII of FIG. 5, which show a sequence of seven different operating configurations for actuating one embodiment of a moulding method according to the invention;

FIGS. 8A and 9A show two enlarged details, respectively, of the two sections of FIGS. 8 and 9;

FIGS. 13 to 18 show six sections, in a vertical elevation, of a second embodiment of a moulding apparatus made according to the present invention, in a sequence of six different operating configurations;

FIG. 19 is a sectioned perspective view of a moulding apparatus made according to the present invention and provided with a distributor arranged at a vertical rotation axis of a conveying carousel for conveying the moulding units, in which the distributor adjusts the feeding of the vacuum, coming from a suction feature outside the carousel, to the various moulding units according to the angular position thereof during rotation of the carousel;

FIG. 20 is a section in a vertical elevation of the apparatus of FIG. 19;

FIG. 21 is an enlarged detail of FIG. 20;

FIG. 22 is a sectioned perspective view of a moulding apparatus made according to the present invention in which feeding of the vacuum to the moulding units, according to the angular position thereof during rotation of the carousel, occurs via an electric joint in combination with a fluid distributor joint;

FIG. 23 is an enlarged detail of FIG. 22;

FIG. 24 is a partial section in a vertical elevation of the moulding apparatus of FIG. 22;

FIG. 25 is a perspective view of a moulding apparatus made according to the present invention in which feeding of the vacuum to the moulding units, according to the angular position thereof during rotation of the carousel, occurs via a cam profile that drives mechanically the valves (one for each moulding unit);

FIG. 26 shows the moulding apparatus of FIG. 25 in a sectioned view from another perspective;

FIG. 27 is a partial section in a vertical elevation of the apparatus of FIG. 25.

### DETAILED DESCRIPTION

For the sake of simplicity, identical elements of different embodiments will be indicated below by the same reference numbers.

1 indicates overall a capsule production plant, comprising a moulding apparatus for compression-moulding a dose D of material on an object U (in particular, on a capsule for closing containers), and an application apparatus 3 connected in line to the moulding apparatus 2 (upstream of the moulding apparatus 2) for applying a dose D of material to the object U and then feeding the object U to the moulding apparatus 2.

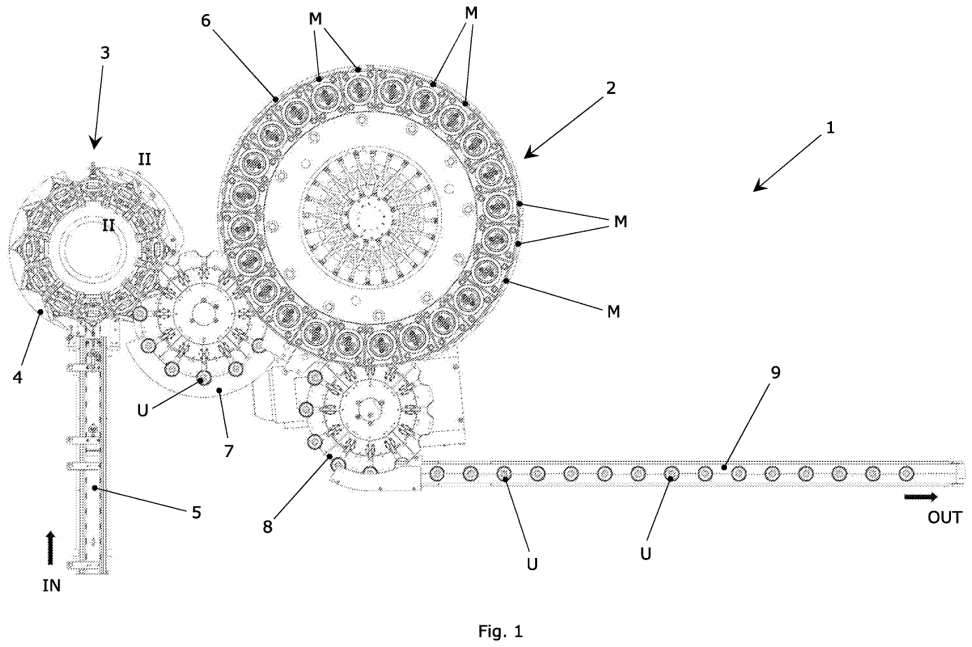

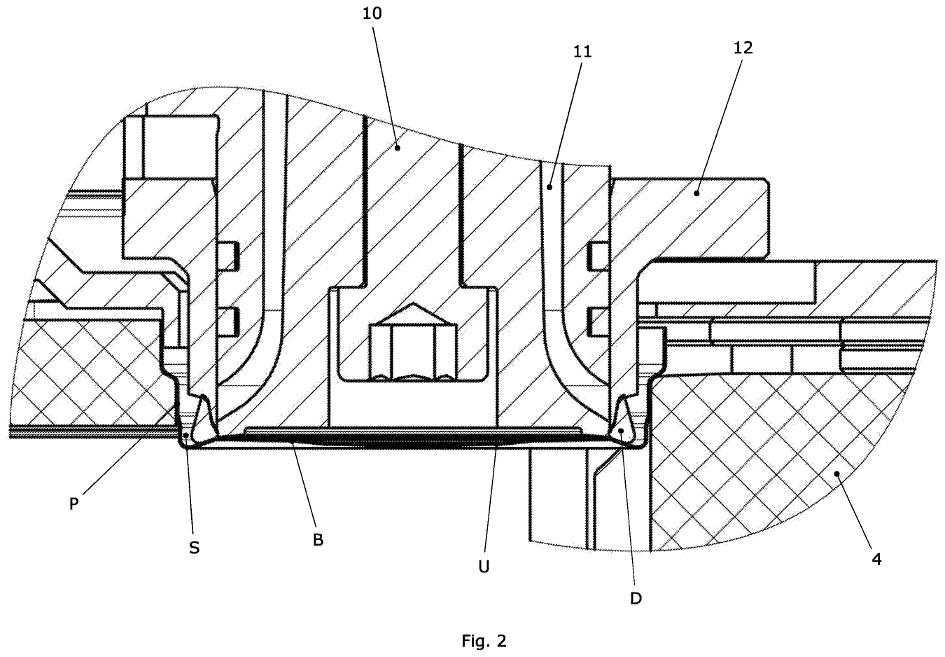

The object U comprises a cup body with a base B and a side wall P connected to the base B. The base B is intended to close an opening of a neck of a container to which the capsule is applied. The side wall P is intended to surround and engage the neck of the container. The object U is fed with a concavity of the cup body facing upwards. The application apparatus 3 comprises an application carousel 4 that can rotate around a vertical rotation axis (in use, with clockwise rotation, with reference to FIG. 1).

The plant 1 comprises a first conveyor 5 (for example, a linear conveyor) that conveys the objects U from an inlet IN and feeds the objects U one by one (aligned on one another), to the application apparatus 3. The moulding apparatus 2 comprises a moulding carousel 6 that can rotate around a vertical rotation axis (in use, with clockwise rotation, with reference to FIG. 1).

The plant 1 comprises a first transferring carousel 7 that can rotate around a vertical rotation axis (in use, with anticlockwise rotation with reference to FIG. 1) to transfer the objects from the application carousel 4 to the moulding carousel 6. The plant 1 comprises a second transferring carousel 8 that can rotate around a vertical rotation axis (in use, with anticlockwise rotation with reference to FIG. 1) for transferring the objects from the moulding carousel 6 to a second conveyor 9 (for example, a linear conveyor) that conveys the objects U, one by one (aligned on one another), to an outlet OUT.

The application apparatus 3 (FIG. 2) comprises a feeder 10 in which at least one channel 11 is formed for feeding the material to at least one material outlet extending along a circumferential direction. The application apparatus 3 comprises a separator 12 that surrounds the feeder 10 and that is configured to separate a dose D of material (in particular, an annular dose D) from the material outlet. The separator 12 and the feeder 10 are movable coaxially with respect to one another. The application apparatus 3 is configured to deposit the dose D of material on the base B of the object U at a distance from the side wall P of the object U so as to generate an annular space S that is comprised between the dose D and the side wall P (FIG. 2). This annular space is a space where, in general, there is a greater risk of air bubbles forming trapped between the material that will be compression moulded on the capsule and the cup body of the capsule.

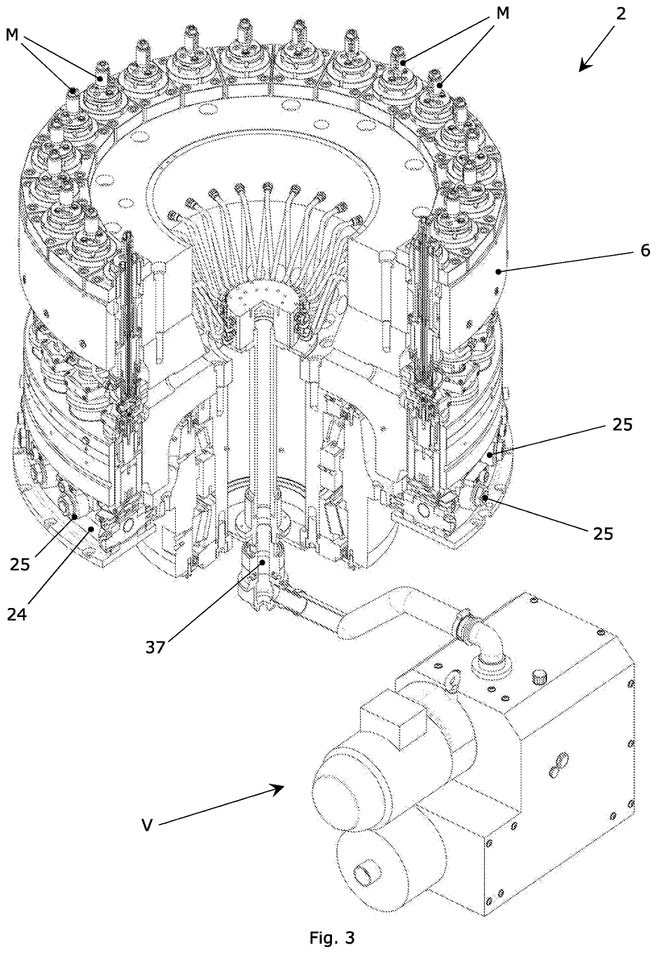

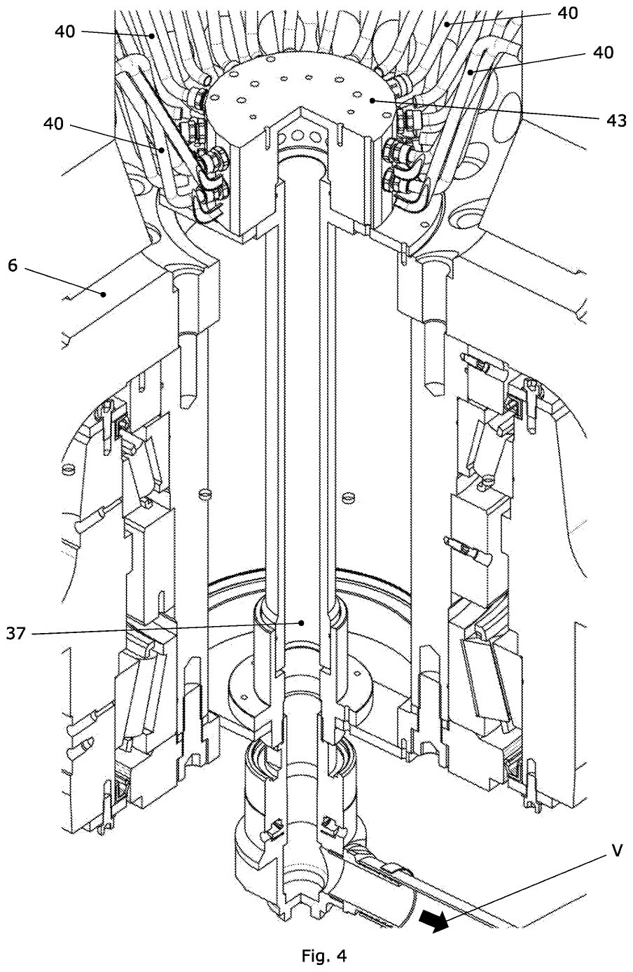

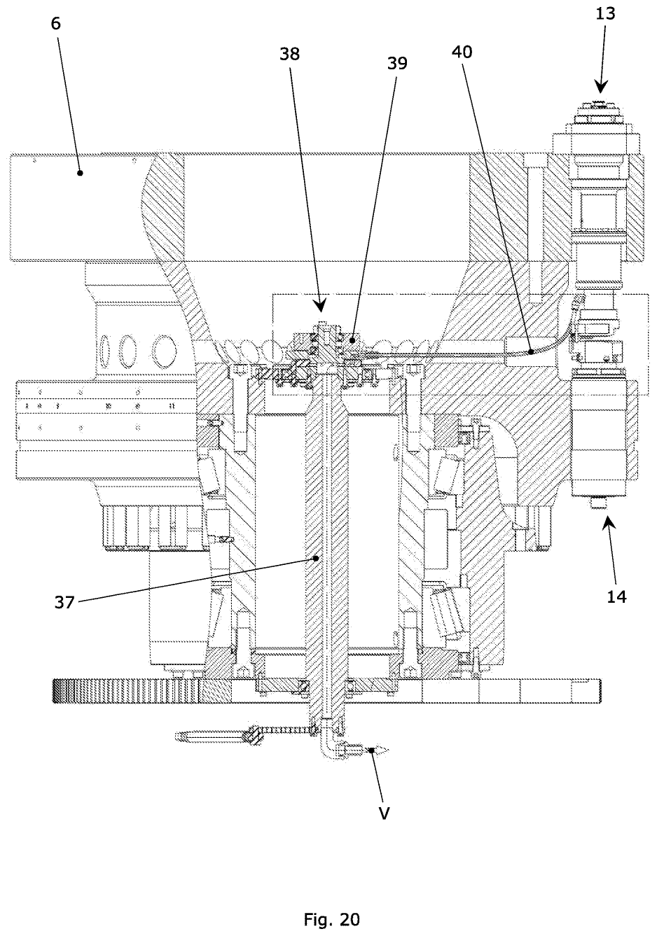

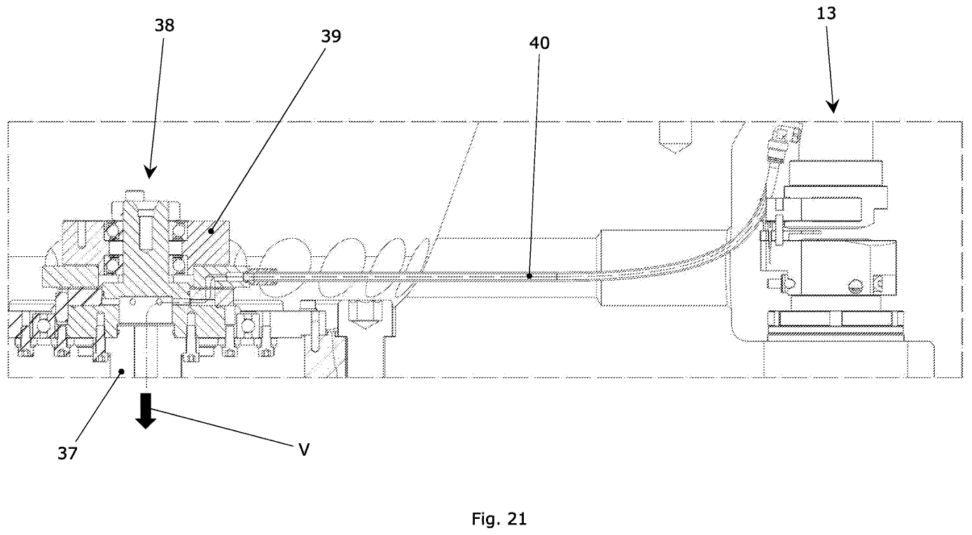

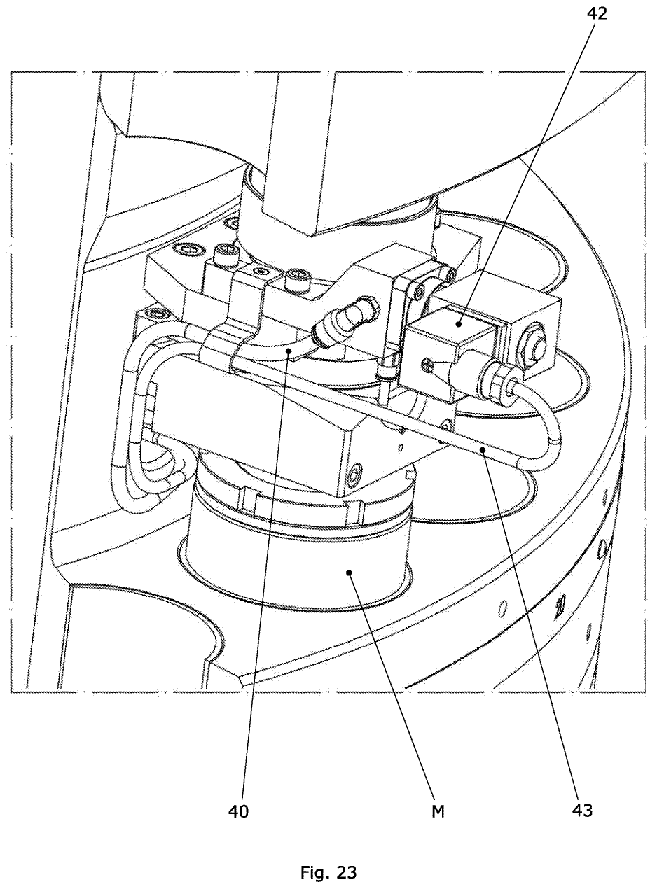

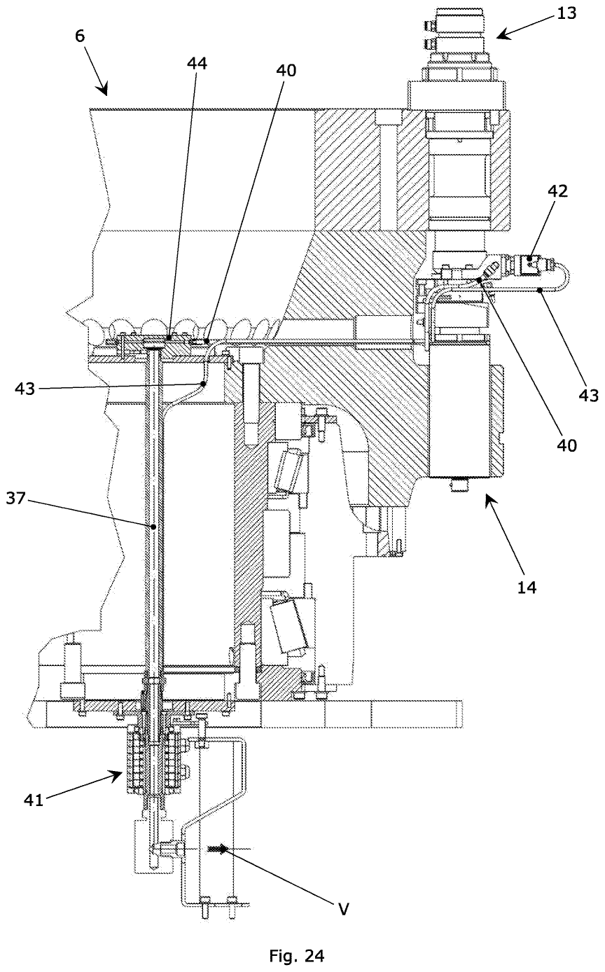

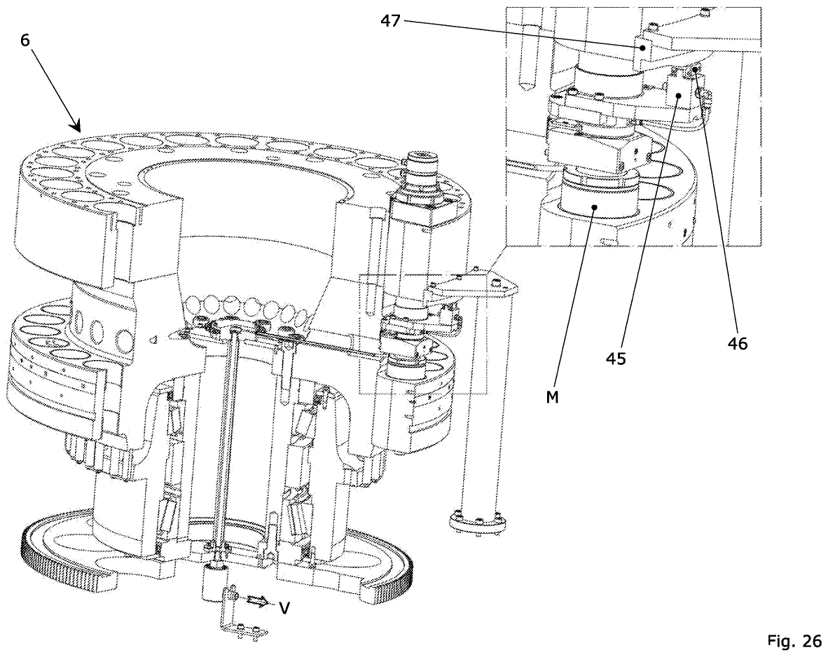

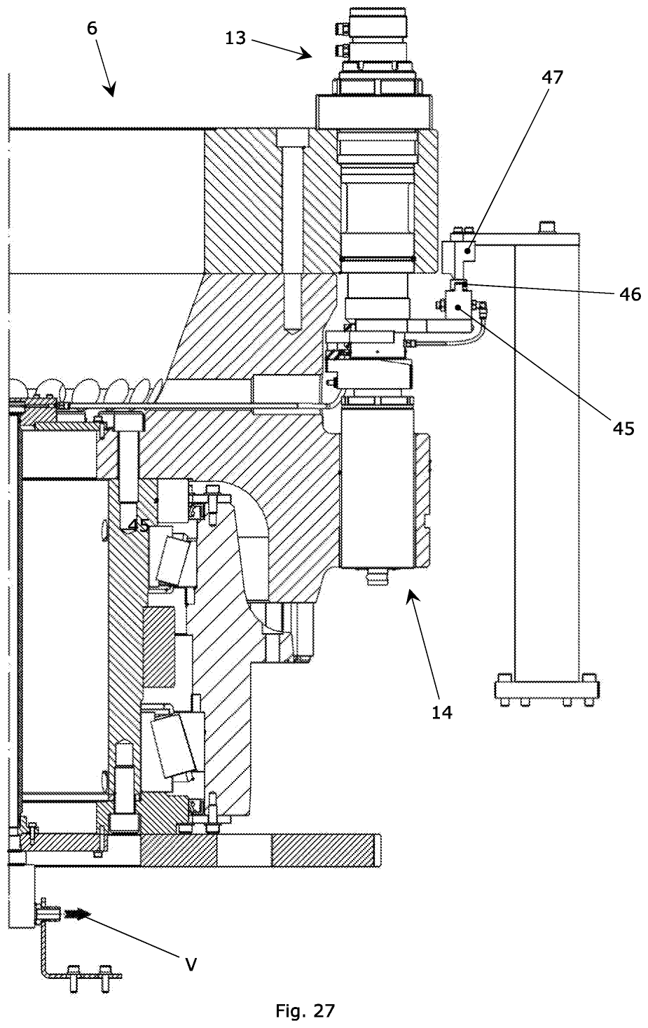

The moulding apparatus 2 (FIGS. 3-27) comprises a suction V configured to generate a vacuum. The moulding apparatus 2 comprises one or more moulding units M connected to the aforesaid suction V. The suction V may comprise, in particular, an apparatus (in particular, mechanical) configured to create and maintain a pressure condition that is less than atmospheric pressure. The suction V may comprise, in particular, a vacuum pump that removes the gas (air) contained in a vacuum chamber that is obtained inside each moulding unit M and to which the pump is connected through a pneumatic circuit. The suction V may comprise, in particular, a vacuum pump (for example, a vacuum pump outside the moulding carousel 6 as in the disclosed embodiments) or other devices suitable for air rarefaction.

The moulding apparatus 2 may comprise, in particular, two or more compression moulding units M (for example, more than twenty moulding units M, as in the illustrated embodiments). The moulding apparatus 2 may comprise, in particular, a moulding carousel 6 which rotates the moulding units M around a vertical rotation axis. The moulding units M are arranged spaced angularly apart around the rotation axis of the moulding carousel 6.

Each compression moulding unit M comprises an upper half-unit 13 and a lower half-unit 14 which can be moved with respect to each other in a moulding direction (vertical direction).

In these specific embodiments, a movable part of the lower half-unit 14 is guided to perform an active ascent movement and a return descent movement guided by a guide system that may comprise, in particular, a cam guide system. Each lower half-unit 14 is configured, in particular, for supporting an object U (capsule for closing containers).

Each upper half-unit 13 comprises an annular portion 15 and a moulding portion 16 which can be moved with respect to one another in the moulding direction.

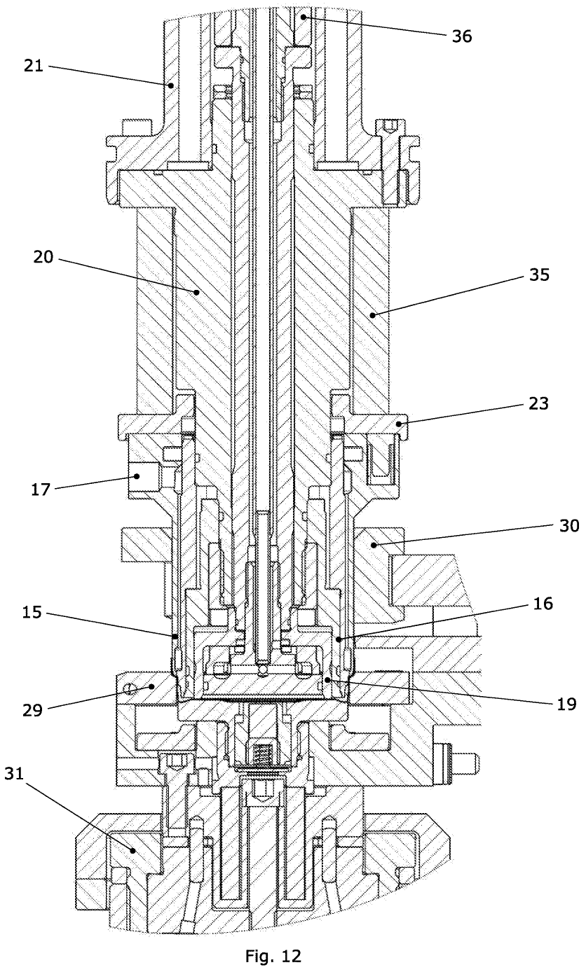

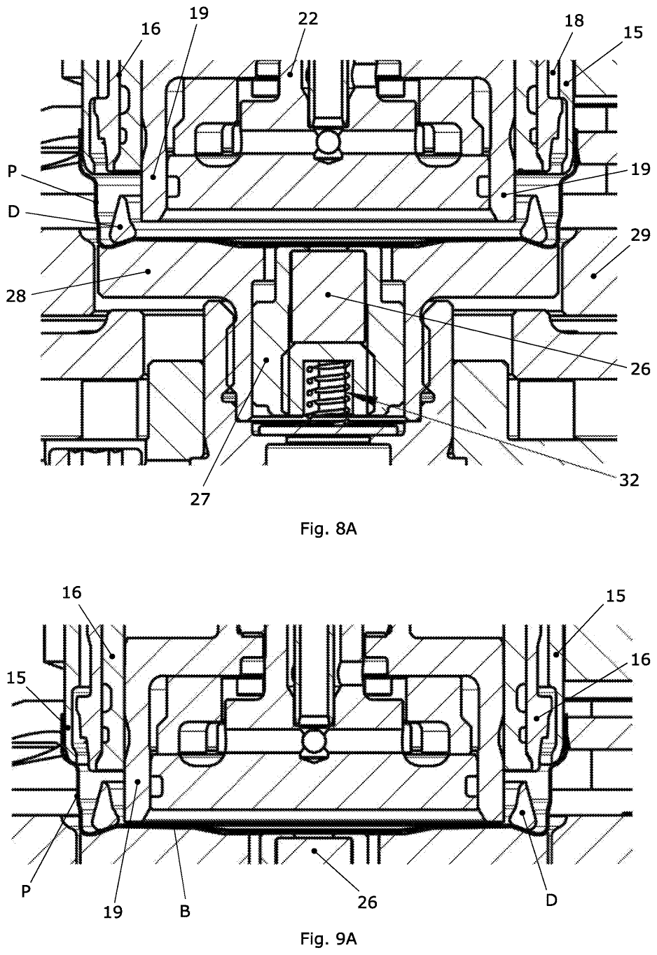

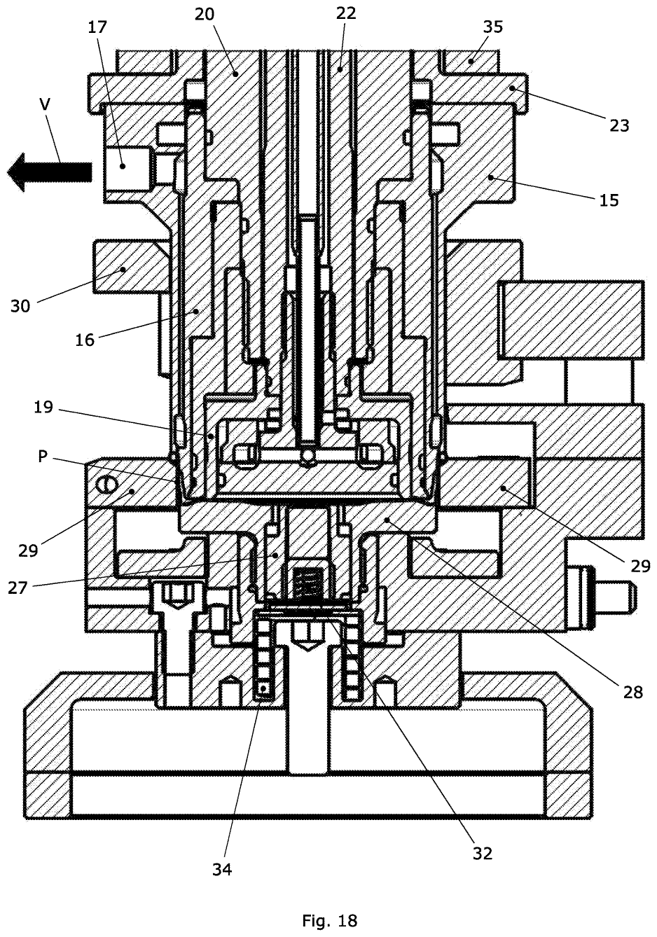

Each compression moulding unit M is configured so as to adopt a moulding configuration (FIG. 12 and FIG. 18) in which the moulding portion 16 contributes to defining a moulding cavity for compression moulding of material (in particular, sealing material for gaskets) on an object U (in particular, a capsule) supported by the lower half-unit 14 so as to form a moulded body (in particular, a gasket).

The moulding portion 16 may be made, in particular (as in these embodiments), in at least two pieces that are couplable with one another coaxially to facilitate assembly thereof. The annular portion 15 may be arranged, in particular, around the moulding portion 16. The upper half-unit 13 may comprise, in particular, at least one port 17 connected to the suction feature V. The port 17 may be arranged, in particular, on the annular portion 15.

The upper half-unit 13 comprises at least one internal volume 18 connected to the port 17 connected to the suction V. The internal volume 18 may be defined, in particular, between the annular portion 15 and the moulding portion 16. The internal volume 18 may comprise, in particular, an annular gap defined between the annular portion 15 and the moulding portion 16. The internal vacuum volume 18 communicates with the port 17 connected to the suction feature V and is closed on one side by an annular sealing area defined by two annular surfaces in reciprocal contact. One of the two annular surfaces may be arranged on the annular portion 15 and the other of the two annular surfaces may be arranged on the moulding portion 16. The annular sealing area may be, in particular, a circumferential zone coaxial with a compression axis (which defines a moulding direction), in particular a vertical compression axis, with which the moulding portion 16 compresses the dose D.

The moulding portion 16 may be, in particular, annular in shape. The upper half-unit 13 may comprise, in particular, an internal portion 19 arranged inside the moulding portion 16 to bound internally the moulding cavity. The internal portion 19 and the moulding portion 16 may be, in particular, moved with respect to one another in the moulding direction. The internal portion 19 may comprise, in particular, an annular lower end protruding downwards and designed to contact the base B of the object U.

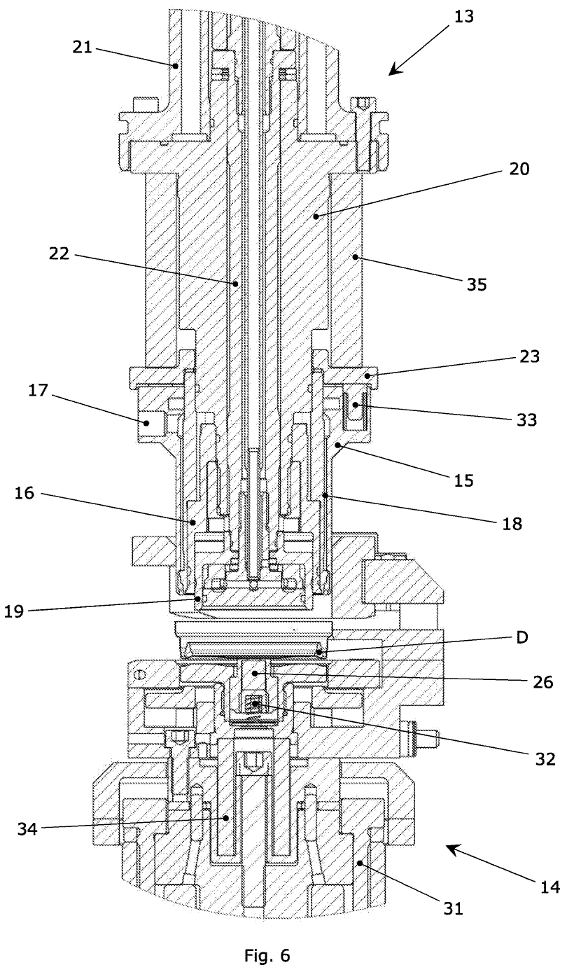

In an initial position (see, for example, FIG. 6), the annular portion 15 may be, in particular, taken by the moulding portion 16. The annular portion 15 may comprise, in particular, an annular surface that is engageable in contact with an annular surface of the moulding portion 16 to open and close an annular access passage to the internal volume 18. In an initial position (see, for example, FIG. 6), the annular surface of the annular portion 15 may be, in particular, in a resting relationship with the annular surface of the moulding portion 16.

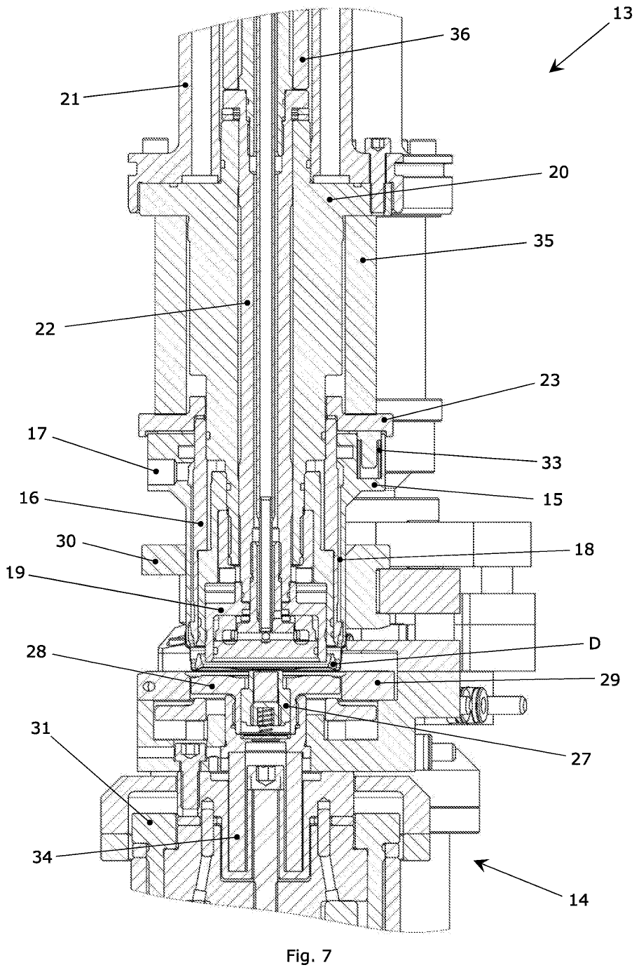

The upper half-unit 13 and a vertically movable part of the lower half-unit 14 are movable axially (vertically) with respect to one another so as to adopt a position (see, for example, FIG. 7) in which there is a sealing contact between the annular portion 15 of the upper half-unit 13 and a contact portion of the side wall P of the object U. When this sealing contact occurs a closed chamber is defined that includes the space intended to form the moulding cavity. This space, in particular, includes the annular space S interposed between the dose D and the side wall P where there is a greater risk of air inclusions during compression moulding. This annular space S is bounded, in particular, by the portion of the object U that identifies a transition zone between the base B and the side wall P.

The chamber defined by the contact between the annular portion 15 and the contact portion is connectable to the suction V through the internal volume 18 (as will be explained better below) and thus through the port 17 to suck air from the moulding cavity and thus avoid an air pocket between the object U and the material of the body (gasket) that is compression moulded on the object U.

The upper half-unit 13 may comprise, in particular, a base support 20 fixed to a frame 21 that rotates integrally with the moulding carousel 6. The base support 20 may comprise, in particular, a sleeve portion. The base support 20 may be, in particular, a part of the upper half-unit 13 that remains stationary in a vertical direction, for example by being fixed to a frame 21 rotating integrally with the moulding carousel 6. The base support 20 may comprise, in particular, a flange portion for connecting to the frame 21.

The moulding portion 16 may be, in particular, connected to the base support 20 by removable fixing means (for example fixing means comprising a fixing ring nut).

The upper half-unit 13 may comprise, in particular, an inner body 22 slidable axially with respect to the base support 20. The inner body 22 may comprise, in particular, a longitudinal portion housed slidingly inside the sleeve portion of the base support 20. The inner body 22 may comprise, in particular, a flange portion restingly supported by the base support 20. The inner body 22 may, in particular, carry the internal portion 19 of the upper half-unit 13. The internal portion 19 may be, in particular, carried integrally by the inner body 22. The internal portion 19 may be, in particular, arranged at a lower end of the inner body 22. Inside the internal portion 19, it is possible to obtain, in particular, a circuit for a cleaning fluid.

The upper half-unit 13 may comprise, in particular, an annular body 23 slidable axially along the moulding direction with respect to the base support 20. The annular body 23 may be arranged, in particular, around a cylindrical surface of the base support 20. The annular body 23 may be, in particular, coaxial with the base support 20. The annular body 23 may be, in particular, slidable axially (vertically) along the moulding direction with respect to the moulding portion 16.

The moulding apparatus 2 may comprise, in particular, control means configured to control a reciprocal displacement between the upper half-unit 13 and the lower half-unit 14 so that the annular portion 15 of the upper half-unit 13 comes into contact with a contact portion of a side wall P of the object U supported by the lower half-unit 14.

The control means may comprise, in particular, a guide system (for example, a cam guide system as in the specific embodiments disclosed here) configured to guide an ascent and descent movement of a vertically movable part of the lower half-unit 14. The control means may comprise, in particular, cam means configured to command displacements in a vertical direction of the movable part of the lower half-unit 14. The cam means may comprise, in particular, a fixed cam profile 24 coupled with a cam follower 25 associated with a respective lower half-unit 14. The cam profile 24 may extend, in particular, in a circumferential direction around the rotation axis of the moulding carousel 6 to follow the circular path of the various moulding units M rotated by the moulding carousel 6.

The lower half-unit 14 may comprise, in particular, a support for carrying the object U. The support may comprise, in particular, two elements that are movable with respect to one another in the moulding direction. One of these two elements may comprise, in particular, fixing means 26 (for example, of magnetic type, in particular a magnet) for fixing the object U in position on the support.

The two elements of the support may be, in particular, a central element 27 and a peripheral element 28. The central element 27 may rest on a central part of the base B of the object U. The peripheral element 28 may rest on a peripheral part of the base B of the object U. The fixing means 26 may be arranged, in particular, on the central element 27 of the support.

The lower half-unit 14 may comprise, in particular, a containment wall 29. The support for carrying the object U and the containment wall 29 are movable axially with respect to one another between a first position, in which the containment wall 29 surrounds a side wall P of the object U carried by the support (corresponding to a lowered position of the lower half-unit 14), and a second position in which the containment wall 29 is lowered with respect to the side wall P of the object U (corresponding to a raised position of the lower half-unit 14).

The lower half-unit 14 may comprise, in particular, a guide sleeve 30 that surrounds coaxially a cylindrical surface of the annular portion 15 of the upper half-unit 13 and can slide axially with respect to the annular portion 15. The guide sleeve 30 may be, in particular, integral with the containment wall 29. The lower half-unit 14 may comprise, in particular, a structure 31 that is movable axially in a vertical direction and that carries the containment wall 29. The guide sleeve 30 may be, in particular, carried by the structure 31 of the lower half-unit 14.

The moulding apparatus 2 may comprise, in particular, first elastic means 32 arranged to exert a first elastic force on the support which carries the object U, in particular when the contact portion of the side wall P of the object U carried by the base of the lower half-unit 14 is brought into contact with the annular portion 15 of the upper half-unit 13. The first elastic means 32 may be, in particular, arranged in the lower half-unit 14. The first elastic means 32 may be, in particular, arranged between the two elements (central element 27 and peripheral element 28) of the support which carries the object. The first elastic means 32 determines an elastic force on the object U, in particular when the contact portion of the side wall P of the object U meets the annular portion 15, i.e. when the contact starts that enables the aforesaid chamber to be closed, inside the object U and including the dose D, in which a vacuum has to be generated to evacuate the air.

The moulding apparatus 2 may comprise, in particular, second elastic means 33 arranged to exert a second elastic force on the annular portion 15. The second elastic force enables a reciprocal displacement to be performed between the annular portion 15 and the moulding portion 16 (after the contact has started between the side wall P and annular portion 15), so as to open the internal volume 18 so that the aforesaid chamber is put into communication with the internal volume 18 and therefore with the suction V.

The second elastic force may be, in particular, greater than the first elastic force. The second elastic means 33 may be arranged, in particular, in the upper half-unit 13. The second elastic means 33 may be arranged, in particular, between the annular portion 15 and the annular body 23. The second elastic means 33 may be housed, in particular, in a cavity of the annular portion 15.

The moulding apparatus 2 may comprise, in particular, third elastic means 34 arranged to exert a third elastic force on the support which carries the object U, in particular a third elastic force on the peripheral element 28. The third elastic force enables a relative axial displacement to be performed between the support which carries the object U and the containment wall 29. Owing to this relative axial displacement (in which the support lowers with respect to the wall), the containment wall 29 can go to position itself in the first position in which the containment wall 29 surrounds the side wall P of the object U carried by the lower half-unit 14. The third elastic force may be, in particular, greater than the first elastic force. The third elastic force may be, in particular, greater than the second elastic force. The third elastic means 34 may be arranged, in particular, in the lower half-unit 14. The third elastic means 34 may be arranged, in particular, between the support which carries the object U (in particular, between the peripheral element 28 of the support) and the structure 31 of the lower half-unit 14 which carries the containment wall 29. The third elastic means 34 may operate between the support which carries the object U and the containment wall 29.

The moulding apparatus 2 may comprise, in particular, fourth elastic means 35 arranged to exert a fourth elastic force on the annular body 23. The fourth elastic force may be, in particular, greater than the third elastic force. The fourth elastic force may be, in particular, greater than the second elastic force. The fourth elastic force may be, in particular, greater than the first elastic force. The fourth elastic means 35 may be arranged, in particular, in the upper half-unit 13. The fourth elastic means 35 may be arranged, in particular, between the base support 20 and the annular body 23 (where the annular body 23 is slidable axially in the moulding direction with respect to the base support 20 and where the annular body 23 can interact in contact with the annular portion 15). In an initial configuration (FIGS. 6-8) it is possible to provide for the annular portion 15 being axially distant from the annular body 23 (for example, by about 1 millimetre) in the moulding direction.

The moulding apparatus 2 may comprise, in particular, fifth elastic means 36 arranged to exert a fifth elastic force on the internal portion 19, in particular to enable the internal portion 19 to be lifted (together with the annular portion 15) with respect to the moulding portion 16, when the dose D is compressed. The fifth elastic means 36 may operate, in particular, in parallel with the fourth elastic means 35. The fifth elastic means 36 may be arranged, in particular, in the upper half-unit 13. The fifth elastic means 36 may be arranged, in particular, between the inner body 22 and the frame 21 of the moulding unit M fitted to the moulding carousel 2. The fifth elastic force (in cooperation with the fourth elastic force) permits an effective seal of the material compressed by the moulding portion 16 inside the moulding cavity.

The moulding apparatus 2 may comprise, in particular, a suction circuit which places the suction feature V in communication with the port 17 and, thus, with the internal volume 18 and with the aforesaid chamber inside the object U, when the annular passage is opened between the annular portion 15 and the moulding portion 16. The suction circuit may comprise, in particular, a central duct 37 connected to the suction V and arranged with a duct axis that is coaxial with the rotation axis of the moulding carousel 6.

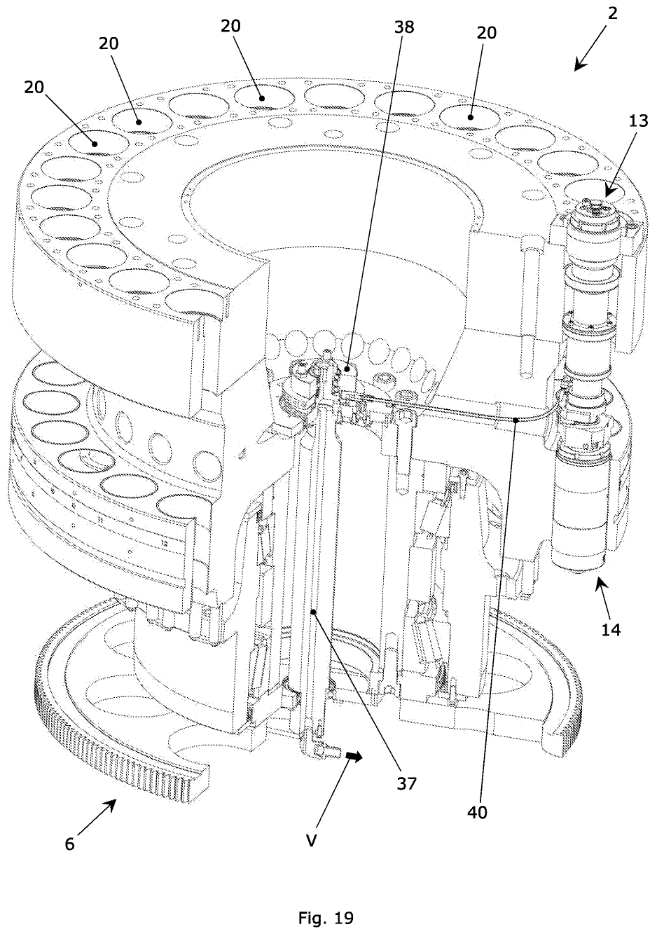

The moulding apparatus 2 may comprise, in particular, a fluid distributor 38 with a (central) fixed part equipped with a route connected to the central duct 37 and with a (peripheral) rotating part 39 equipped with two or more routes each of which is connected to a respective moulding unit M via a vacuum conveying pipe 40 (embodiment of FIGS. 19-21) rotated by the moulding carousel 6. The fluid distributor 38 is so configured that during the rotation of the moulding carousel 6 and for each rotated moulding unit M, the route connected to the moulding unit M is open so as to receive the suction effect from the route connected to the central duct 37, only in the portion of the circular path of the moulding unit M where suction is actually necessary to evacuate the air from the annular space S.

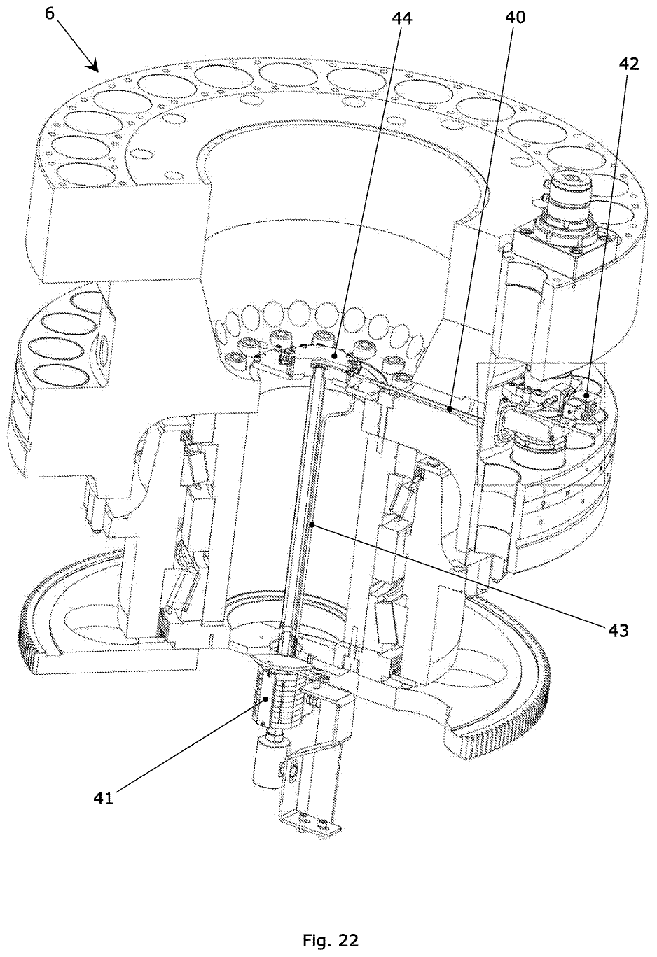

The moulding apparatus 2 may comprise, in particular, an electric rotary joint 41 (embodiment of FIGS. 22-24) arranged at the rotation axis of the moulding carousel 6 to control two or more solenoid valves 42 (one for each moulding unit M) through a respective electric conduit 43 (one for each moulding unit M). Each solenoid valve 42 controls opening of the communication of a pipe 40 which carries the vacuum to a respective moulding unit M only at the portion of the circular path of the moulding unit M where suction is actually necessary to evacuate the air from the annular space S.

The moulding apparatus 2 may comprise, in particular, two or more pipes 40 each of which is rotated by the moulding carousel 6 and is connected, on one side, to the central duct 37 by means of a rotating fluid distributor joint 44 and, on another side, to a respective moulding unit M.

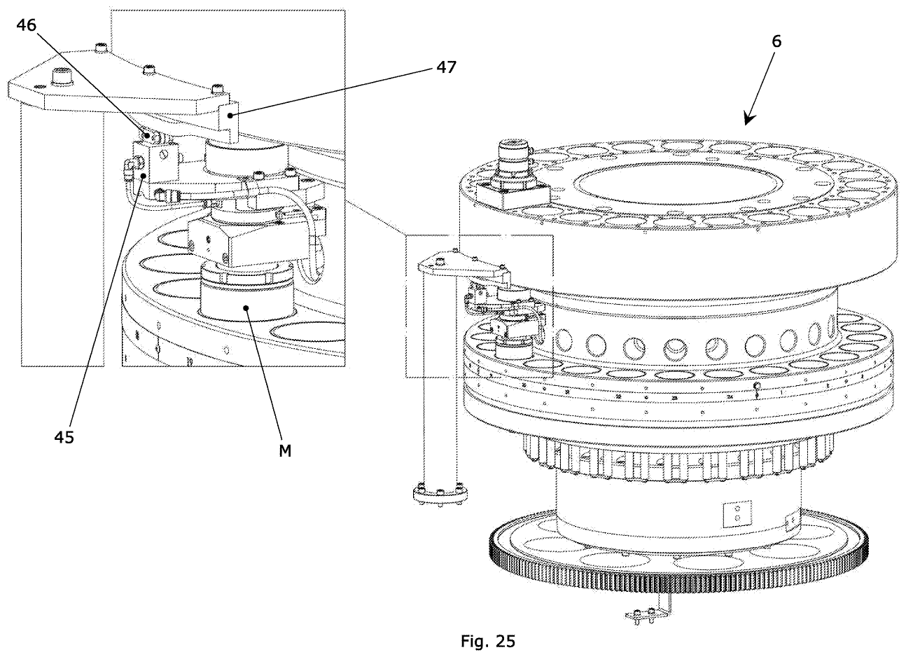

The moulding apparatus 2 may comprise, in particular, two or more shut-off valves 45 each of which is associated with a respective pipe 40 to open or close the connection between the central duct 37 and the respective moulding unit M. The moulding apparatus 2 may comprise, in particular, two or more cam followers 46 each of which is rotated by the moulding carousel 6 and is coupled with a fixed cam profile 47 to control a respective shut-off valve 45 (FIGS. 25-27).

FIGS. 6 to 12 show one embodiment of an operating sequence of the moulding apparatus 2.

FIG. 6 shows a configuration that corresponds to the moment in which the cam follower 25 of the vertically movable part of the lower half-unit 14 is at a lower point of the cam profile 24. This configuration may correspond, in particular, to an initial position in which the object U can be received by the lower half-unit 14 and/or in which the object U carried by the lower half-unit 14 is far from the upper half-unit 13.

By continuing the rotation of the moulding unit M (in this specific embodiment or after a rotation by an angle α1), the cam profile 24 will have lifted the movable part of the lower half-unit 14 as far as the position of FIG. 7 (and FIG. 7A), in which the annular portion 15 of the upper half-unit 13 (that that has stayed stationary in a vertical direction) is in contact with the upper contact portion of the side wall P of the object U (that was raised) so as to close the chamber bounded by the object U and by the lower portion of the upper half-unit 13. This chamber includes the annular space S comprised between the dose D and the side wall P of the object U, i.e. the space at risk of air inclusions being formed in a subsequent step of compression moulding of the material of the dose D.

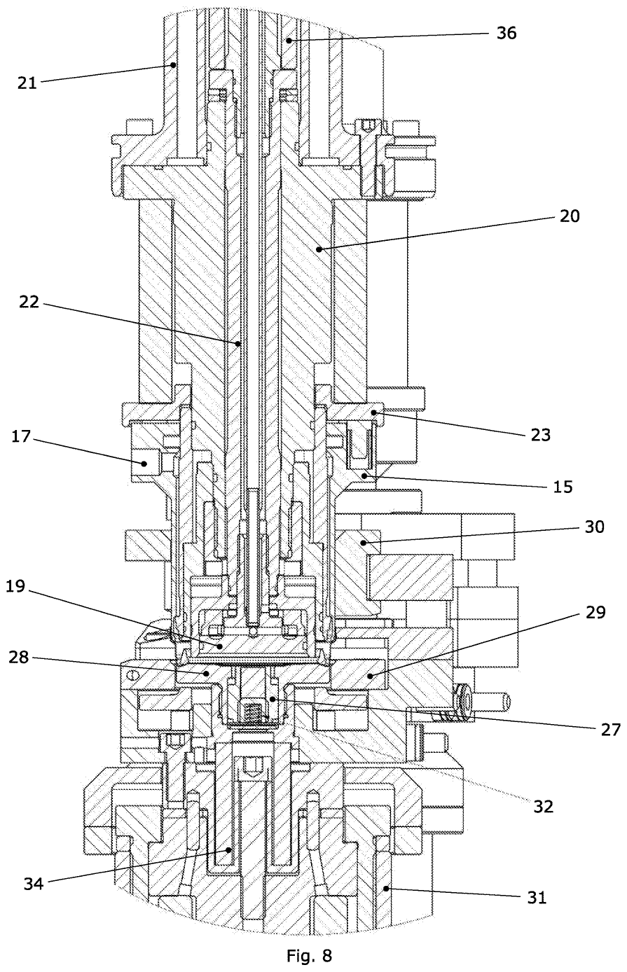

By continuing the rotation of the moulding unit M (in this specific embodiment or after a rotation by an angle α2 from the initial start position of the ascent of the cam profile 24), the cam profile 24 will have lifted the movable part of the lower half-unit 14 as far as the position of FIG. 8 (and FIG. 8A), in which the first elastic means 32 is compressed, so that an elastic force exists (first elastic force determined by the stiffness of the first elastic means 32) between the central element 27 and the peripheral element 28 of the support of the object. The side wall P of the object U continues to remain in contact with the annular portion 15 of the upper half-unit 13.

In this step (from the position of FIG. 7 to the position of FIGS. 8 and 8A) the movable part of the lower half-unit 14 has lifted (apart from the central element 27 of the support that was in contact with the object U and supported the object U with fixing in position by the fixing means 26, in particular with a magnetic connection) so that the peripheral element 28 of the support lifts up as far as the contact of the peripheral element 28 with the base B of the object U.

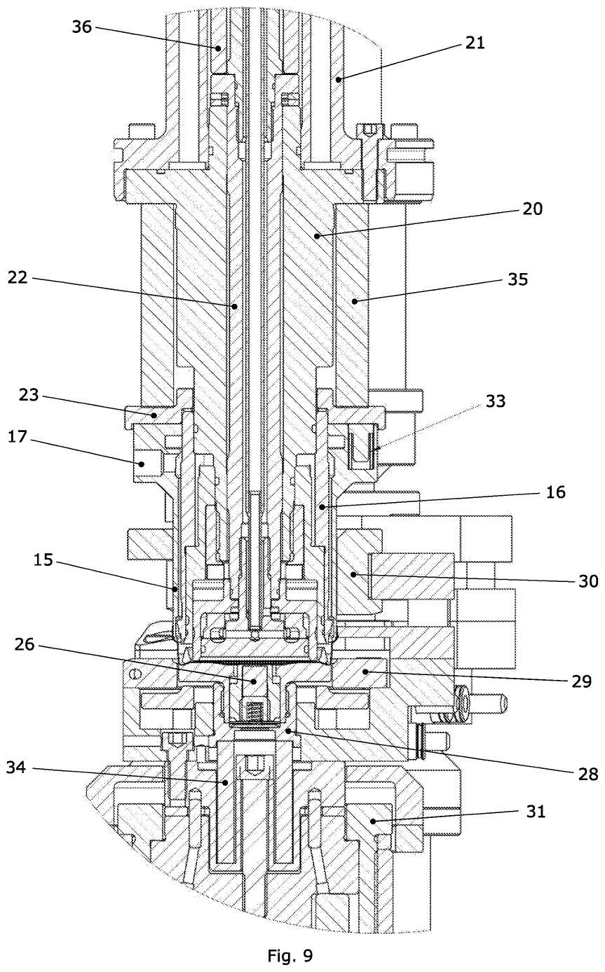

By continuing the rotation of the moulding unit M (in this specific embodiment after a rotation by an angle α3 from the initial position), the cam profile 24 will have lifted the movable part of the lower half-unit 14 as far as the position of FIG. 9 (as FIG. 9A), in which the second elastic means 33 is compressed. The second elastic means 33, which operates between the annular body 23 and the annular portion 15, transmits an elastic force onto the side wall P of the object U through the annular portion 15. The second elastic means 33 generates an elastic force (second elastic force determined by the stiffness of the second elastic means 33) between the annular portion 15 of the upper half-unit 13 and the side wall P of the object U. The second elastic force is greater than the elastic force generated by the first elastic means 32 (first elastic force).

In this step (from the position of FIGS. 8 and 8A to the position of FIGS. 9 and 9A) the movable part of the lower half-unit 14 has lifted and also the annular portion 15 of the upper half-unit 13 has been pushed upwards (whereas the rest of the upper half-unit 13, in particular the moulding portion 16, remained stationary in a vertical direction) until the annular portion 15 comes to abut (after a stroke, for example, of about 1 millimetre) on a stroke stop arranged on an annular body 23 of the upper half-unit 13.

The moulding portion 16 remains stationary in a vertical direction, so that lifting of the annular portion 15 causes opening of the annular passage between the moulding portion 16 and the annular portion 15 that opens communication between the connecting port 17 connecting with the suction V and the aforesaid chamber inside the object U and including the annular space S between the dose D and the side wall P of the object U, so that a vacuum is created in a chamber and suction of air from the chamber occurs.

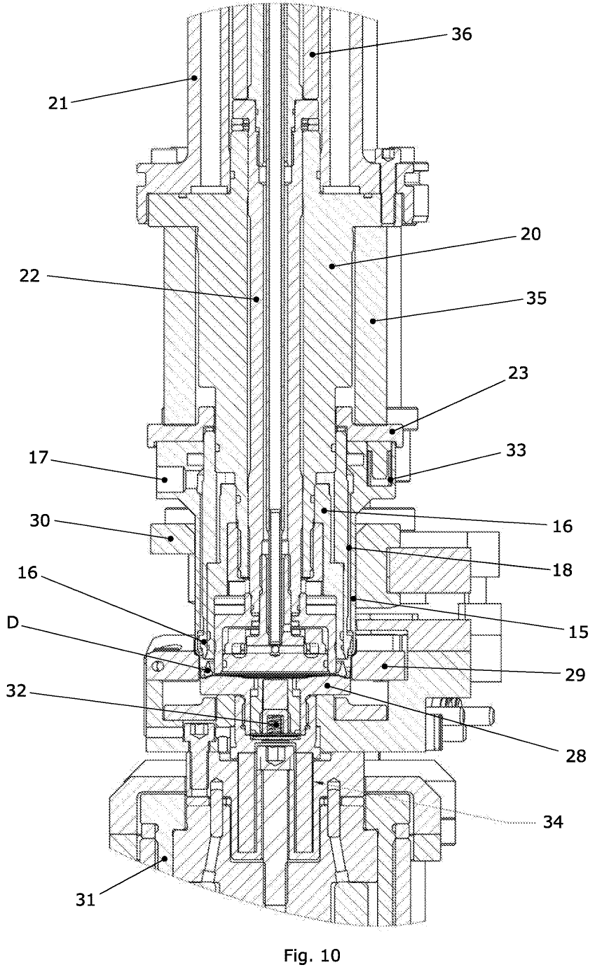

By continuing the rotation of the moulding unit M (in this specific embodiment after a rotation by an angle α4 from the initial position), the cam profile 24 will have lifted the movable part of the lower half-unit 14 further as far as the position of FIG. 10, in which the third elastic means 34 is compressed, so that an elastic force exists (third elastic force determined by the stiffness of the third elastic means 34) between the structure 31 (with which the containment wall 29 is integral) and the support (elements 27 and 28) which carries the object U. The third elastic force is greater than the elastic force exerted by the second elastic means 33 (second elastic force).

In this step (from the position of FIG. 9 to the position of FIG. 10), the containment wall 29 is positioned around the side wall P of the object U. In this step, the structure 31, i.e. the part that includes the containment wall 29, comes to abut on a stroke stop arranged on the part that includes the support which carries the object U.

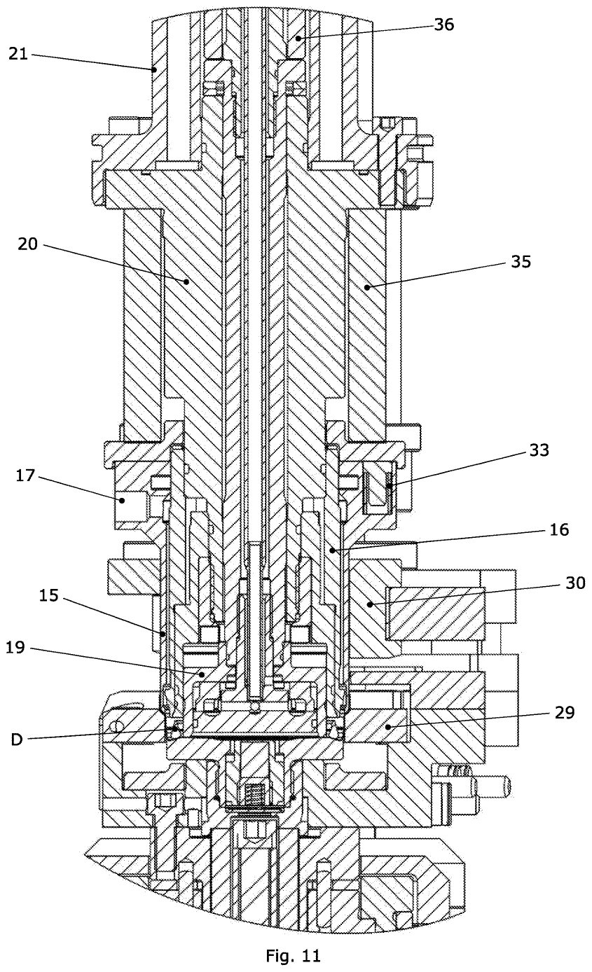

By continuing the rotation of the moulding unit M (in this specific embodiment after a rotation by an angle α5 from the initial position), the cam profile 24 will have lifted the movable part of the lower half-unit 14 as far as the position of FIG. 11, in which the object U carried by the support of the lower half-unit 14 has arrived with the inside of the base B thereof in contact with the internal portion 19 of the upper half-unit 13 (in particular, with the peripheral annular end of the internal portion 19 protruding axially downwards), i.e. with the portion that will come to bound the moulding cavity internally.

In this step (from the position of FIG. 10 to the position of FIG. 11) it is possible for the fourth elastic means 35 (operating between the annular body 23 and the base support 20) to be compressed, generating a fourth elastic force (determined by the stiffness of the fourth elastic means 35). The fourth elastic force can be, in particular, greater than the third elastic force and/or greater than the second elastic force. The fourth elastic force can contribute to the seal of the inner edge of the moulding cavity bounded by the internal portion 19.

By continuing the rotation of the moulding unit M (in this specific embodiment after a rotation by an angle α6 from the initial position), the cam profile will have lifted the movable part of the lower half-unit 14 further as far as the position of FIG. 12, in which the movable part of the lower half-unit 14 has ascended and has pushed upwards the part of the upper half-unit 13 that includes the internal portion 19 and the annular portion 15. The moulding portion 16 remained stationary in a vertical direction, causing the action of compression moulding of the dose D in the moulding cavity.

In this step (from the position of FIG. 11 to the position of FIG. 12) it is possible for the fourth elastic means 35 to be further compressed and for the fifth elastic means 36 to be compressed in addition. In this step, moreover, there is upward sliding of the inner body 22 with respect to the base support 20 and of the annular body 23 with respect to the base support 20.

The moulding unit M will continue to rotate, carried by the moulding carousel 6, to go in sequence to a yielding zone, in which the moulding unit M surrenders the object U with the moulded body to an outlet conveyor (second transferring carousel 8), then to a pick-up zone, in which the moulding unit M picks up another object U with the dose to be moulded coming from an inlet conveyor (first transferring carousel 7), then continues to advance along the loop (circular) path to return to the position of FIG. 6 and start another moulding cycle as far as the position of FIG. 12. The moulding carousel 6 comprises a plurality of moulding units M distributed angularly so that each moulding unit M can perform a complete moulding cycle as disclosed above.

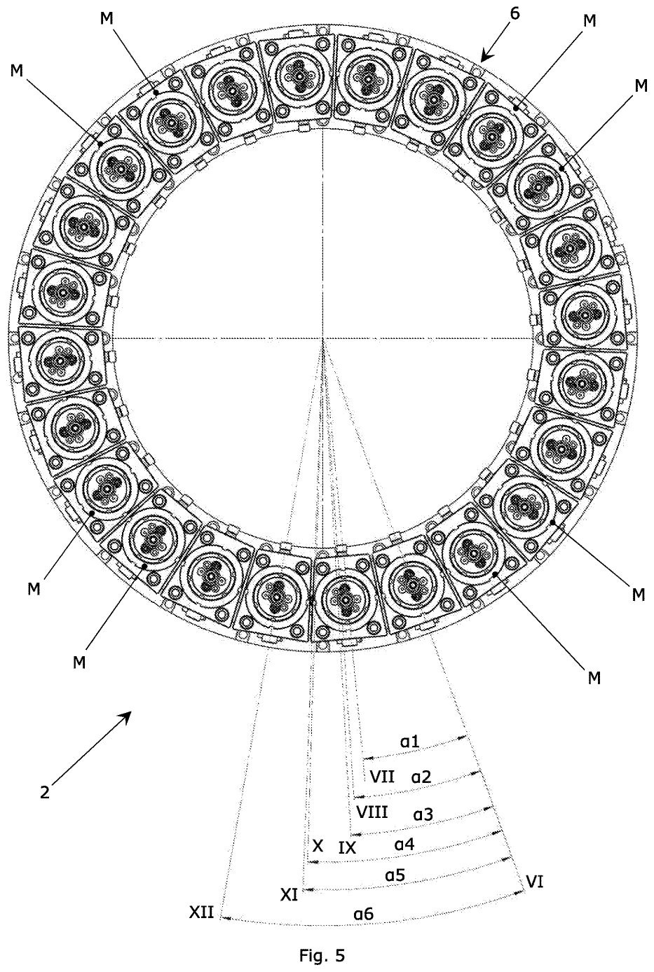

In one embodiment (in particular, see FIGS. 5 to 12), the annular portion 15 may be, in particular, so shaped and arranged that in the closed mould configuration (FIG. 12), the annular portion 15 contributes to bounding the moulding cavity, together with the moulding portion 16, with the internal portion 19 and with a part of the object U (in particular, with the part of object U that comprises the transition zone between the base B and the side wall P).

In the closed mould configuration, the annular portion 15 may have an annular surface in contact with an annular surface of the moulding portion 16 for closing the moulding cavity. In this embodiment, in the closed mould configuration the annular portion 15 can thus enter into contact with the material of the dose D.

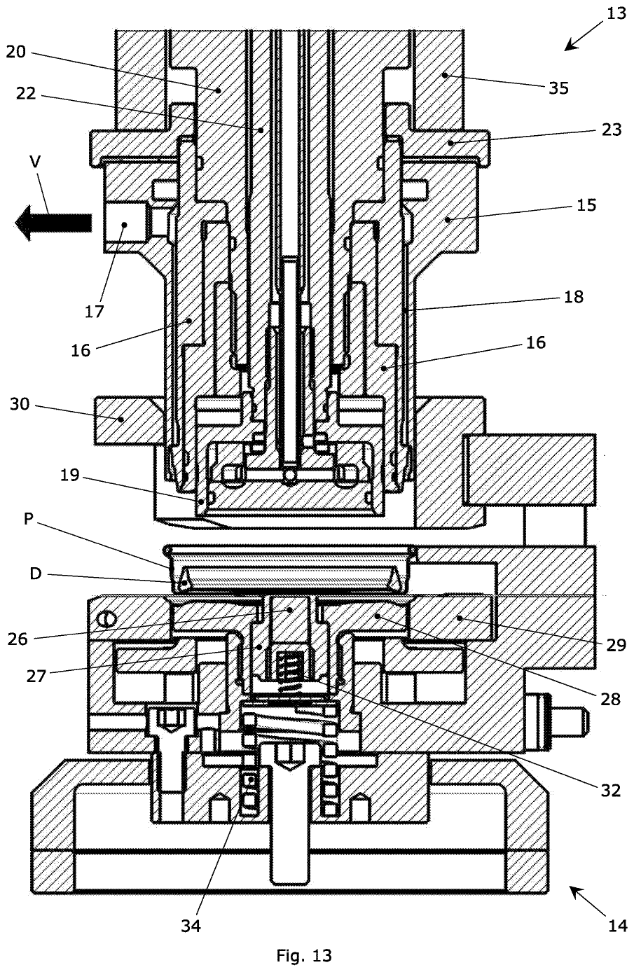

In one embodiment (in particular, see FIGS. 13 to 18), the annular portion 15 may be, in particular, so shaped and arranged that, in the closed mould configuration (FIG. 18), the annular portion 15 does not bound the moulding cavity and/or does not enter into contact with the material of the dose D. In this embodiment, in the closed mould configuration the moulding portion 16 has an annular surface in contact with an inner annular surface of the side wall P of the object U (capsule) for closing the moulding cavity directly between the object U and the moulding portion 16.

It is noted that in the embodiment of FIGS. 13 to 18 the third elastic means 34, which is arranged between the annular portion 15 and the annular body 23, is also present although not visible in the figures. In this embodiment as also in other embodiments, it is possible for the annular portion 15 to be restingly supported by the moulding portion 16. In this embodiment as also in other embodiments, it is possible for the annular body 23 to be restingly supported by the moulding portion 16.

It is also possible to provide, in this embodiment as also in other embodiments, for a distance being set (for example of about 1 millimetre) between the annular portion 15 and the annular body 23, to allow an axial stroke between the annular portion 15 and the annular body 23.

In the initial position of FIG. 13, the lower half-unit 14 is lowered and at a distance from the upper half-unit 13 (just as in the position of FIG. 6).

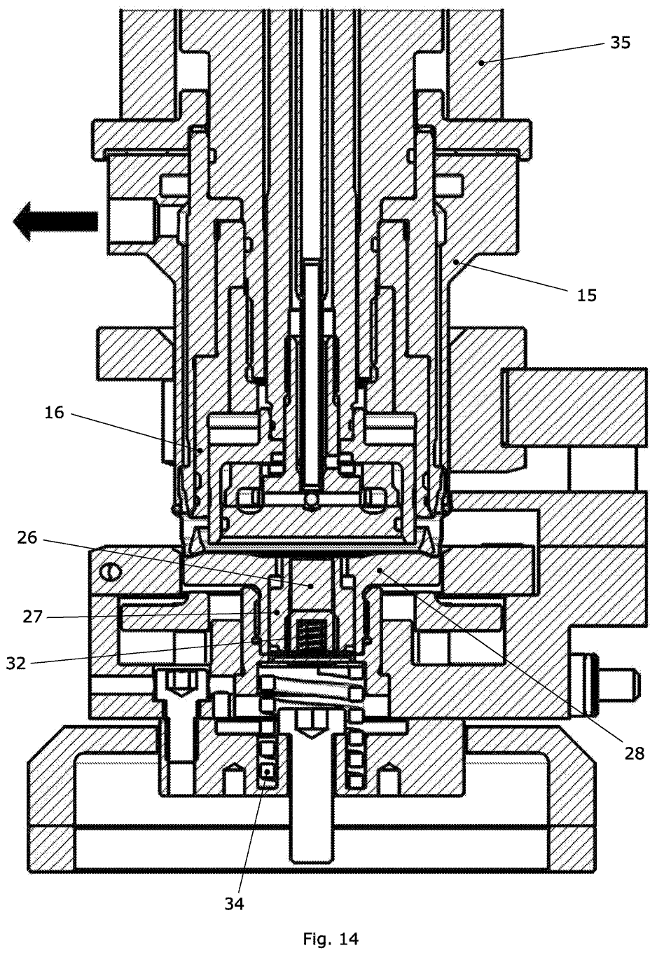

The movable part of the lower half-unit 13 is lifted as far as the position of FIG. 14 in which the first contact of the side wall P of the object U with the annular portion 15 of the upper half-unit 13 occurs. During this lifting, the first elastic means 32 is compressed (just as in the position of FIG. 8).

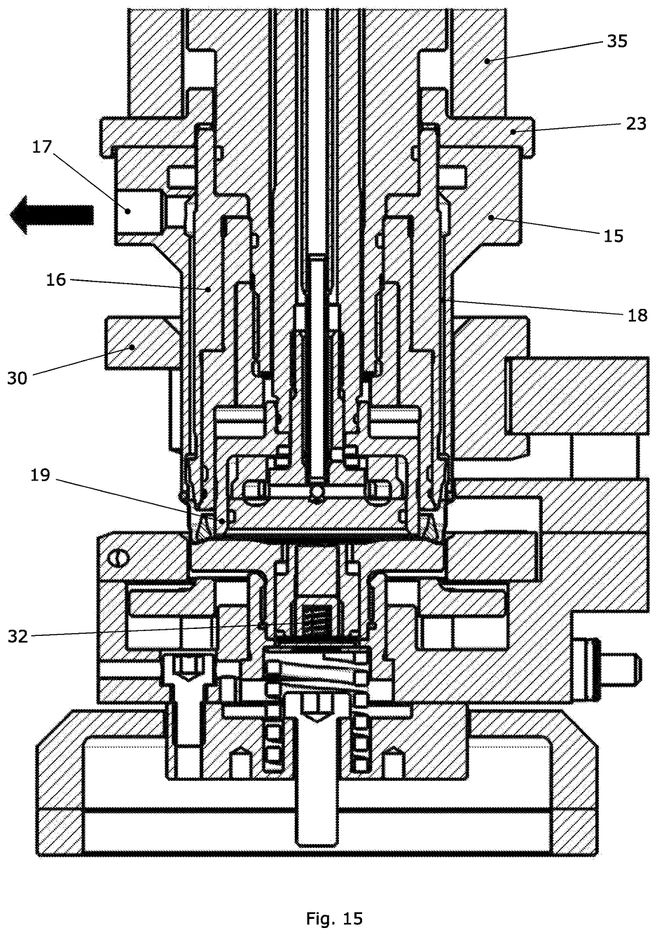

The movable part of the lower half-unit 14 continues lifting as far as the position of FIG. 15 in which the connecting passage is opened connecting to the suction feature V between the annular portion 15 and the moulding portion 16 to create a vacuum in the chamber inside the object U in the moulding zone to evacuate the air. At the end of this lifting the annular portion 15 comes to abut against the annular body 23 (just as in the position of FIG. 9).

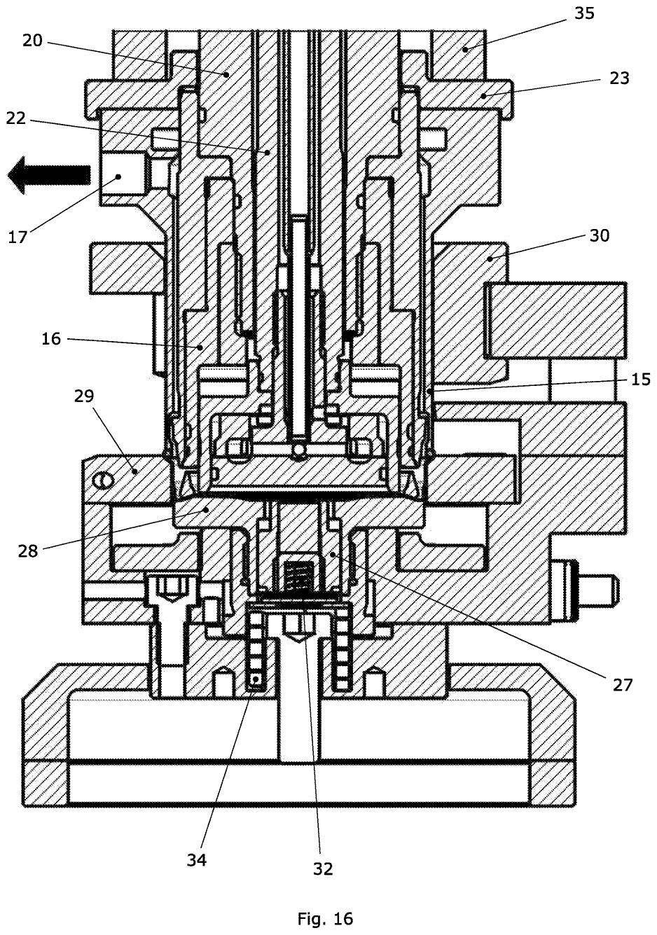

The movable part of the lower half-unit 14 continues lifting as far as the position of FIG. 16 in which the containment wall 29 is in the first position, i.e. in the position in which it surrounds the object itself laterally (just as in the position of FIG. 10).

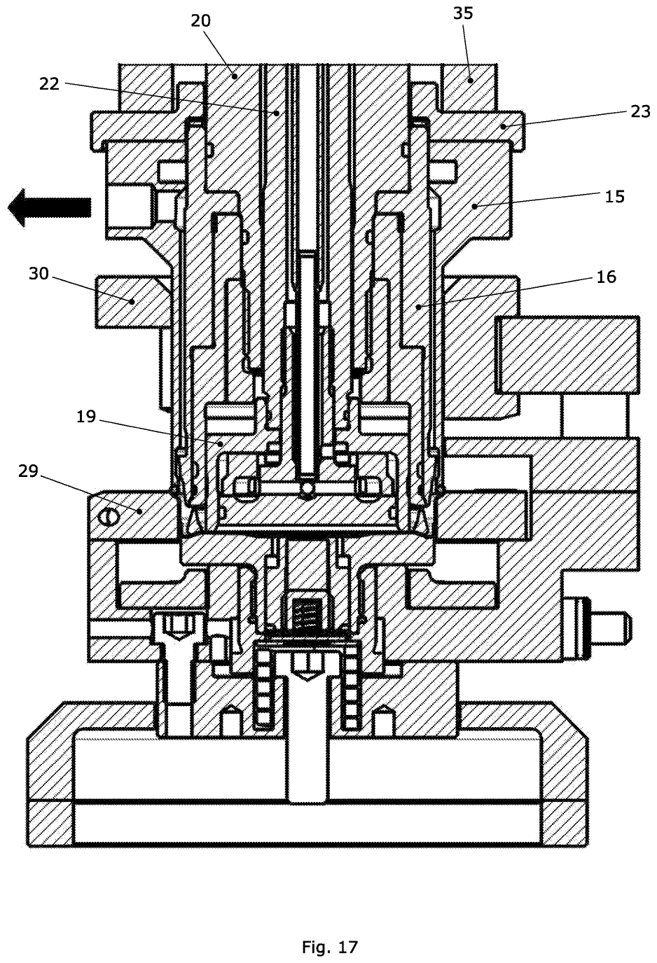

The movable part of the lower half-unit 14 continues lifting as far as the position of FIG. 17 in which the base B of the object U comes to abut against the internal portion 19 to generate a seal zone for inner closing of the moulding cavity before compression moulding by the moulding portion 16 (just as in the position of FIG. 11).

The movable part of the lower half-unit 14 continues lifting as far as the position of FIG. 18 in which the object U and the movable parts of the upper half-unit 13 (annular portion 15 and internal portion 19) are so lifted that the moulding portion 16, which remains fixed in a vertical direction, can compress the material of the dose D in the moulding cavity preventing the formation of air bubbles owing to the preceding suction (just as in the position of FIG. 12).

The vacuum in the annular space S may be, in particular, pressure lower than 400 mbar absolute pressure, in particular lower than 300 mbar absolute pressure or 200 mbar absolute pressure. An effect of substantial absence of air inclusions in the moulded body (gasket) with vacuum values falling within the range 150-200 mbar absolute pressure, although it is nevertheless possible to obtain an effective result with less extreme vacuum values. The vacuum pump used permits a vacuum up to 100 mbar absolute pressure, although it is possible to use other pumps or other types of suction.

As has been seen, in all the embodiments disclosed, a closed chamber is generated that includes the compression moulding zone and that is placed in a vacuum to suck in air from the moulding zone (in particular from the annular space S comprised between the dose D deposited on the base B of the object U and the side wall P of the object U) before compression, in which the chamber is closed by a contact between the side wall P of the object U and a portion of the moulding unit M, in particular an annular portion 15 of the upper half-unit 13 of the moulding unit M.

As said, the suction V may comprise, in addition to or instead of the vacuum pump, other devices suitable for rarifying the air. It is possible, for example, to use a Venturi effect device, or mechanisms suitable for generating a vacuum exploiting the movement of movable parts of the moulding carousel 6, in which the aforesaid movement may be driven and guided by the same rotation movement of the moulding carousel 6.

It is possible to provide a moulding method with some variants on what has been disclosed previously, modifying the intervention times of the elastic means 32, 33, 34, 35, 36, making the elastic means 32, 33, 34, 35, 36 more or less anticipated with respect to what was disclosed previously, also with a different intervention order of the elastic means 32, 33, 34, 35, 36, and/or modifying the stiffness of the elastic means 32, 33, 34, 35, 36.

For example, in one version, it is possible to provide, during the rotation of the moulding unit M, the following sequence of steps, nevertheless suitable for sucking a relatively reduced volume of air, with an anticipated intervention of the fifth elastic means 36 before the elastic means 33 to 35. In a first step, the internal portion 19 in the upper half-unit 13 enters into contact with the object U. After which, in a second step, the first elastic means 32 is compressed until it brings the object U into contact with the peripheral element 28 of the support of the object U. After which, in a third step, the fifth elastic means 36 is compressed so as to bring the annular portion 15 in the upper half-unit 13 into contact with the side wall P of the object U. After which, in a fourth step, the second elastic means 33 is compressed and the fifth elastic means 36 is compressed further so as to open communication between the suction V and the chamber that includes the annular space S, until the annular portion 15 abuts on the annular body 23. After which, in a fifth step, the third elastic means 34 is compressed so as to reach the configuration in which the object U, carried by the support to the lower half-unit 14, is surrounded laterally by the containment wall 29. After which, in sixth step, the fourth elastic means 35 and the fifth elastic means 36 are compressed so as to reach the moulding configuration in which the dose D of material is compression moulded in the moulding cavity.

### LEGEND

1 Capsule production plant
2 Moulding apparatus
3 Application apparatus
4 Application carousel
5 First conveyor
6 Moulding carousel
7 First transferring carousel
8 Second transferring carousel
9 Second conveyor
10 Feeder of the material in the application apparatus
11 Channel of the feeder
12 Separator of the dose in the application apparatus
13 Upper half-unit of the moulding unit
14 Lower half-unit of the moulding unit
15 Annular portion in the upper half-unit
16 Moulding portion in the upper half-unit
17 Port connected to suction feature
18 Volume inside the upper half-unit
19 Portion inside the upper half-unit
20 Base support in the upper half-unit
21 Frame
22 Inner body
23 Annular body
24 Cam profile
25 Cam followers
26 Fixing means
27 Central element of the support of the object
28 Peripheral element of the support of the object
29 Containment wall
30 Guide sleeve
31 Structure of the lower half-unit
32 First elastic means
33 Second elastic means
34 Third elastic means
35 Fourth elastic means
36 Fifth elastic means
37 Central duct
38 Fluid distributor
39 Rotating part of the fluid distributor
40 Vacuum conveying pipe
41 Electric rotary joint
42 Solenoid valves
43 Electric ducts
44 Fluid distributor joint
45 Shut-off valves
46 Cam followers
47 Cam profile
D Dose of material
U Object (capsule)
B Base of the object
P Side wall of the object
S Annular space
IN Inlet
OUT Outlet
V Suction
M Moulding unit

1. Compression moulding method, comprising the steps of:
feeding an object, which comprises a base and a side wall connected to said base, with a concavity facing upwards;
depositing a dose of material on said base at a distance from said side wall so as to generate an annular space that is comprised between said dose and said side wall;
defining a chamber, which includes said annular space, bringing a contact portion of said side wall into contact with an annular portion of a moulding unit;
compressing said dose by a moulding portion of said moulding unit to form a moulded body;
before said compressing step, generating a vacuum in said annular space putting said chamber in communication with a suction, in particular in order to prevent the formation of an air inclusion between the moulded body and the object.

2. Method according to claim 1, comprising, before said step of defining a chamber, the step of defining inside said moulding unit an internal volume communicating with said suction and closed by one side by an annular sealing area defined by two annular surfaces in reciprocal contact; it being provided, in particular, for one of said two annular surfaces to be arranged on said annular portion and the other of said two annular surfaces to be arranged on said moulding portion; said internal volume being defined, in particular, between said annular portion and said moulding portion; said internal volume comprising, in particular, an annular gap defined between said annular portion and said moulding portion; said annular sealing area being, in particular, a circumferential zone coaxial with a compression axis, in particular vertical, with which said moulding portion compresses said dose.

3. Method according to claim 2, wherein said step of generating a vacuum comprises the step of performing a reciprocal displacement between said annular portion and said moulding portion so as to open an annular passage between said two annular surfaces, whereby the opening of said annular passage enables said chamber to communicate with said internal volume.

4. Method according to claim 1, wherein said contact portion of said side wall and said annular portion of said moulding unit are brought into reciprocal contact, after which said chamber is placed in communication with said suction through the effect of a reciprocal displacement between said annular portion and said moulding portion performed by a force that comprises a second elastic force; said second elastic force being exerted, in particular, by second elastic means arranged in said moulding unit and operating on said annular portion; a first elastic force being in particular provided, which is exerted by first elastic means arranged in said moulding unit between two elements of a support that carries the object, said two elements being movable with respect to one another, said first elastic force being less than said second elastic force.

5. Method according to claim 1, comprising, after said step of defining a chamber and before said compressing step of compressing said dose, a step in which a reciprocal axial movement takes place between a containment wall and said object so that said containment wall can laterally surround said side wall.

6. Method according to claim 4, comprising, after said step of defining a chamber and before said compressing step of compressing said dose, a step in which a reciprocal axial movement takes place between a containment wall and said object so that said containment wall can laterally surround said side wall, wherein said reciprocal axial movement is performed by a force that comprises a third elastic force greater than said second elastic force and/or greater than said first elastic force; said third elastic force being exerted, in particular, by means of third elastic means operating in said moulding unit between said support carrying the object and said containment wall.

7. Method according to claim 4, wherein, during said compressing step said dose, said object and said annular portion are lifted with respect to said moulding portion, in particular by exerting a force on said annular portion that comprises a fourth elastic force; there being provided, in particular, after said defining step of defining a chamber and before said compressing step of compressing said dose, a step of lifting said object with respect to an internal portion of said moulding unit arranged inside said moulding portion so that said internal portion comes into contact with said base to bound a moulding cavity during the subsequent compressing step of compressing said dose, after which, in said compressing step of compressing said dose, said internal portion is also lifted with respect to said moulding portion together with said object and said annular portion.

8. Method according to claim 1, wherein said dose deposited on said base is annular in shape and/or wherein said object comprises a capsule for closing containers and/or wherein said material comprises sealing material suitable for forming a gasket and/or wherein said moulded body comprises a gasket.

9. Method according to claim 1, wherein said annular portion and said moulding portion belong to an upper half-unit of said moulding unit and wherein said object is supported by a lower half-unit of said moulding unit; it being provided, in particular, that, during said step of defining a chamber, a movable part of said lower half-unit performs an upward movement to bring said contact portion of said side wall into contact with said annular portion of said upper half-unit.

10. Method according to claim 1, wherein, during said steps of defining a chamber, generating a vacuum and compressing said dose, said object and said moulding unit rotate around a vertical rotation axis of a moulding carousel which carries said moulding unit; said chamber being, in particular, put into communication with said suction through a suction circuit which comprises a central duct connected to said suction and arranged with a duct axis that is coaxial with said rotation axis of said moulding carousel.

11. Moulding apparatus comprising a suction configured to generate a vacuum and one or more moulding units connected to said suction;
each moulding unit comprising an upper half-unit and a lower half-unit which can be moved with respect to each other in a moulding direction; said lower half-unit being configured to support an object; said upper half-unit comprising an annular portion and a moulding portion which can be moved with respect to one another in said moulding direction; a moulding configuration being provided in which said moulding portion defines a moulding cavity for moulding a body on an object supported by said lower half-unit; said annular portion being arranged around said moulding portion; said upper half-unit comprising a port connected to said suction and an internal volume connected to said port and defined between said annular portion and said moulding portion; said moulding apparatus comprising control means configured to control a reciprocal movement between said upper and lower half-units so that said annular portion comes into contact with a contact portion of a side wall of the object supported by said lower half-unit to define a chamber that includes said moulding cavity and that is connectable to said suction through said internal volume to suck air from said moulding cavity and avoid an air inclusion between the moulded body and the object.

12. Apparatus according to claim 11, wherein said moulding portion is annular in shape and said upper half-unit comprises an internal portion arranged inside said moulding portion to bound internally said moulding cavity, said internal portion and said moulding portion being axially movable with respect to each other in said moulding direction.

13. Apparatus according to claim 11, wherein said annular portion comprises an annular surface that is engageable in contact with an annular surface of said moulding portion to selectively open and close an annular passage between said internal volume and said chamber.

14. Apparatus according to claim 11, wherein:
said lower half-unit comprises a support for carrying the object and a containment wall, said support and said containment wall being reciprocally movable with the possibility of adopting a first position, in which said containment wall surrounds a side wall of the object carried by the support, and a second position, in which said containment wall is lowered with respect to said side wall of the object; and/or
said internal volume comprises an annular gap defined between said annular portion and said moulding portion; and/or
said control means comprises cam means configured to command displacements in a vertical direction of a movable part of said lower half-unit; said cam means comprising, in particular, a fixed cam profile coupled with a cam follower associated with said movable part of said lower half-unit.

15. Apparatus according to claim 11, comprising first elastic means arranged to exert a first elastic force on an object carried by said lower half-unit, in particular before the contact portion of the side wall of the object is brought into contact with said annular portion said first elastic means being, in particular, arranged in said lower half-unit between two elements of a support that carries the object, said two elements being movable with respect to one another in said moulding direction; one of said two elements comprising, in particular, fixing means for fixing the object in position on said support, in particular with a fixing force of magnetic type.

16. Apparatus according to claim 11, comprising second elastic means arranged to exert a second elastic force to perform a reciprocal displacement between said annular portion and said moulding portion so as to open a passage for said internal volume so that said chamber is put into communication with said internal volume and therefore with said suction.

17. Apparatus according to claim 11, wherein said lower half-unit comprises a support which carries the object, a containment wall and third elastic means arranged to exert a third elastic force to perform a reciprocal displacement between said support and said containment wall to a position in which said containment wall surrounds a side wall of the object carried by said support.

18. Apparatus according to claim 11, comprising fourth elastic means arranged to exert a fourth elastic force on said annular portion to lift said annular portion with respect to said moulding portion whilst the dose is compressed by said moulding portion; said fourth elastic means being, in particular, arranged in said upper half-unit; said fourth elastic means operating, in particular, between a base support, which carries said moulding portion, and said annular portion, in particular by means of the interposition of an annular body that is interposed between said fourth elastic means and said annular portion and which is axially movable with respect to and around said base support.

19. (canceled)

20. Apparatus according to claim 11, comprising two or more of said moulding units and a moulding carousel which rotates said moulding units around a vertical rotation axis, said apparatus comprising a suction circuit which puts said chamber in communication with said suction and which comprises a central duct connected to said suction and arranged with a duct axis that is coaxial with said rotation axis;
said moulding apparatus comprising, in particular:
a fluid distributor comprising a fixed part equipped with a pneumatic route connected to said central duct and a rotating part equipped with two or more pneumatic routes each of which is connected to a respective moulding unit; or
an electric rotary joint arranged at said rotation axis to control two or more solenoid valves each of which is configured to control a respective pipe which carries the vacuum to a respective moulding unit; or
two or more pipes each of which is rotated by said moulding carousel and is connected, on one side, to said central duct by means of a fluid distributor joint and, on another side, to a respective moulding unit; two or more shut-off valves each of which is associated with a respective pipe to open or close the connection between said central duct and the respective moulding unit; and two or more cam followers each of which is rotated by said moulding carousel and is coupled with a fixed cam profile to control the opening and closing of a respective shut-off valve.

21. Capsule production plant, comprising a moulding apparatus made according to claim 11 and configured to form an annular dose of sealing material to form an annular gasket on a capsule for the closure of a container, and an application apparatus connected in line to said moulding apparatus for feeding a capsule with an annular dose to be moulded, said application apparatus comprising a feeder, in which at least one channel is formed for feeding the material to at least one material outlet extending along a circumferential direction, and a separator that surrounds the feeder and that is configured to separate an annular dose of material from the material outlet, said separator and said feeder being able to move coaxially with respect to each other to deposit the annular dose on a base of the capsule at a distance from a side wall of the capsule so as to generate an annular space that is comprised between the annular dose and the side wall.
